(19) United States
(12) Patent Application Publication
(10) Pub. No.: US 2024/0169594 A1
(43) Pub. Date: May 23, 2024

(54) IMAGE COMMUNICATION SYSTEM, IMAGE COMMUNICATION METHOD, AND IMAGE TRANSMITTING DEVICE

(71) Applicant: RENESAS ELECTRONICS CORPORATION, Tokyo (JP)

(72) Inventors: Osamu FUKUSHIMA, Tokyo (JP); Koki NAGATA, Tokyo (JP)

(21) Appl. No.: 18/482,312

(22) Filed: Oct. 6, 2023

(30) Foreign Application Priority Data
Nov. 21, 2022 (JP) 2022-185622

(51) Int. Cl. G06T 9/00; G06V 10/25; G06V 10/28; G06V 20/56

(52) U.S. Cl. CPC G06T 9/00; G06V 10/25; G06V 10/28; G06V 20/56

(57) ABSTRACT

An image communication system capable of appropriately determining an encoding parameter is provided. In the image communication system according to one embodiment, based on a result of image recognition for a target frame, a region of interest in the target frame is determined. Single or plural reference frames input and stored after a target frame are referred to in chronological order, and the region of interest in the reference frame(s) is predicted. Based on the predicted region of interest predicted in the reference frame(s), the encoding parameter for a new input frame to be encoded is determined.

### CROSS-REFERENCE TO RELATED APPLICATION

The disclosure of Japanese Patent Application No. 2022-185622 filed on Nov. 21, 2022, including the specification, drawings and abstract is incorporated herein by reference in its entirety.

### BACKGROUND

The present disclosure relates to an image communication system, an image communication method, and an image transmitting device.

There is disclosed technique listed below.
[Patent Document 1] Japanese Unexamined Patent Application Publication No. 2016-046707

An image communication system that encodes and transmits frames in an image transmitting device and decodes the received frames in an image receiving device is known. The Patent Document 1 discloses an image communication system that performs image recognition on the frames decoded in real time in the image receiving device and determines the encoding parameter based on the results of the image recognition in the image transmitting device.

### SUMMARY

The inventors have found the following issue concerning the image communication systems. In the image communication system disclosed in the Patent Document 1, the results of image recognition on the frames decoded in the image receiving device are fed back to the image transmitting device, and therefore, a communication delay of, for example, about several frames occurs. In this specification, the communication delay includes delay caused by the image recognition processing.

Accordingly, for example, when the image transmitting device mounted on a vehicle transmits images having been captured by an onboard camera, the images may significantly change during the above communication delay due to the travel of the vehicle. As described above, the encoding parameter is determined in the image transmitting device, based on the results of image recognition in the image receiving device. For this reason, if the image significantly changes during the communication delay, there is a problem of failing to appropriately determine the encoding parameter.

Note that the present disclosure is not limited to the case where the image transmitting device is mounted on the vehicle. The present disclosure is not limited to the case where the image recognition results are fed back from the image receiving device to the image transmitting device, either.

Other problems and novel characteristics will become apparent from the description herein and the accompanying drawings.

In an image communication system according to one embodiment, based on the result of image recognition on a target frame, a region of interest in the target frame is determined. With reference to single or plural reference frames in chronological order input and stored after the target frame, the region of interest in the reference frame is predicted. Based on the predicted region of interest predicted in the reference frame, the encoding parameter for a new input frame to be encoded is determined.

According to the above-described embodiment, it is possible to provide an image communication system that can more appropriately determine the encoding parameter.

### BRIEF DESCRIPTIONS OF THE DRAWINGS

FIG. 1 is a block diagram showing an outline of a configuration of an image communication system according to a first embodiment.

FIG. 2 is a detailed block diagram showing the configuration of the image communication system according to the first embodiment.

FIG. 3 is an image diagram showing a series of processes in the image communication system according to the first embodiment shown in FIG. 2.

FIG. 4 is a flowchart showing an image communication method according to the first embodiment.

FIG. 5 is a detailed block diagram showing a configuration of an image communication system according to a second embodiment.

FIG. 6 is a flowchart showing an image communication method according to the second embodiment.

### DETAILED DESCRIPTION

With reference to the drawings, the specific embodiments will be described in detail below. For the sake of clarity of explanation, the following descriptions and drawings will be omitted or simplified as appropriate. The elements described in the drawings as functional blocks that perform various kinds of processing can be made of a computer including a central processing unit (CPU), memory, and other circuits in terms of hardware, or can be achieved by a program etc., loaded in the memory in terms of software. Accordingly, it is understood by those skilled in the art that these functional blocks can be achieved in various ways by hardware alone, software alone, or a combination thereof, and the achievement is not limited to any of them. In each drawing, the same elements are denoted with the same symbol, and the repetitive explanations thereof are omitted as appropriate.

The program described above includes a command group (or software code) used to make a computer perform one or more functions described in the embodiments when the command (or software code) is loaded into the computer. The program may be stored in a non-transitory computer readable medium or a tangible storage medium. As examples but not limited thereto, the computer readable medium or tangible storage medium includes random-access memory (RAM), read-only memory (ROM), flash memory, solid-state drive (SSD), or other memory techniques, CD-ROM, digital versatile disc (DVD), Blu-ray (registered trademark) disc, or other optical disc storage, magnetic cassette, magnetic tape, magnetic disk storage, or other magnetic storage device. The program may be transmitted on a transitory computer readable medium or communication medium. As examples but not limited thereto, the transitory computer readable medium or communication medium includes electrical, optical, acoustic, or other form of, propagation signals.

### First Embodiment

### Outline of Configuration of Image Communication System

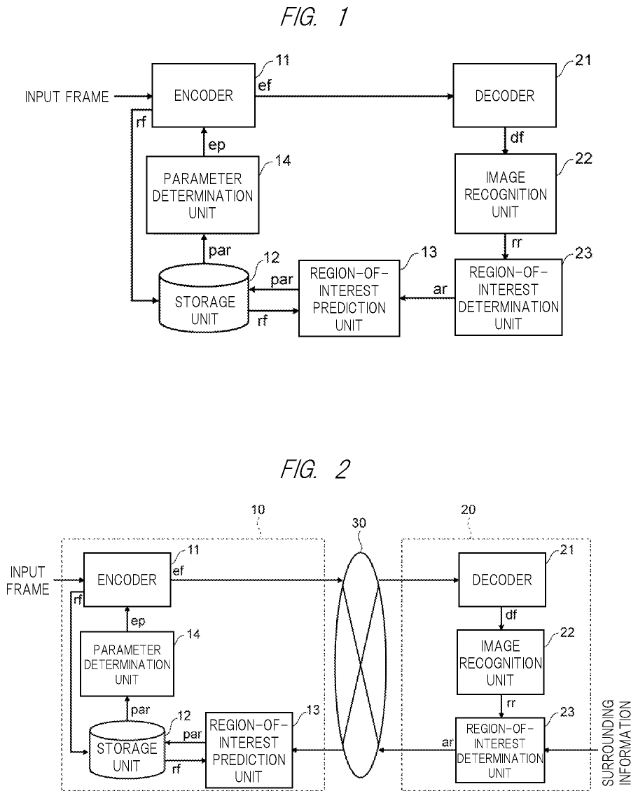

First, with reference to FIG. 1, an outline of a configuration of an image communication system according to a first embodiment will be described. FIG. 1 is a block diagram showing the outline of the configuration of the image communication system according to the first embodiment. As shown in FIG. 1, the image communication system according to the first embodiment includes an encoder 11, a storage unit 12, a region-of-interest prediction unit 13, a parameter determination unit 14, a decoder 21, an image recognition unit 22, and a region-of-interest determination unit 23.

The encoder 11 encodes an input frame which is an image signal, based on an encoding parameter “ep” determined by the parameter determination unit 14. An encoded frame “ef” generated by the encoder 11 is input to the decoder 21. Meanwhile, the encoder 11 outputs, as a reference frame “rf”, the received input frame before being encoded to the storage unit 12.

The storage unit 12 is, for example, a memory, and stores the reference frame rf received from the encoder 11. The storage unit 12 also stores a predicted region of interest “par” predicted by the region-of-interest prediction unit 13 for each reference frame rf. Note that the encoder 11 may include the storage unit 12.

The region-of-interest prediction unit 13 acquires a region of interest ar of the target frame determined by the region-of-interest determination unit 23, and refers to the reference frames rf having been input after the target frame and been stored in the storage unit 12, in chronological order. That is, based on the region of interest ar of the target frame, the region-of-interest prediction unit 13 refers to the reference frames rf input during the communication delay of the target frame in chronological order, and predicts the region of interest of each reference frame rf. Note that the target frame means a frame targeted for the image recognition performed by the image recognition unit 22.

As a result, the region of interest in the new input frame to be encoded by the encoder 11 can be predicted more accurately. The predicted region of interest par of the reference frame rf predicted by the region-of-interest prediction unit 13 is stored in the storage unit 12.

From the storage unit 12, the parameter determination unit 14 acquires the predicted region of interest par of the reference frame rf predicted by the region-of-interest prediction unit 13. Based on the predicted region of interest par of the reference frame rf, the parameter determination unit 14 determines the encoding parameter ep for the new input frame to be encoded, and outputs it to the encoder 11. The encoding parameter ep is determined so that, for example, the region of interest in the new input frame has higher image quality than those of other regions.

The decoder 21 decodes the encoded frame ef generated by the encoder 11, and outputs a decoded frame “df” to the image recognition unit 22.

The image recognition unit 22 performs the image recognition on the decoded frame df generated by the decoder 21 in real time, and outputs an image recognition result “rr” to the region-of-interest determination unit 23. That is, in this embodiment, the target frame to be targeted for the image recognition performed by the image recognition unit 22 is the decoded frame df generated by the decoder 21.

The region-of-interest determination unit 23 determines the region of interest ar in the decoded frame df, based on the image recognition result rr generated by the image recognition unit 22, and outputs it to the region-of-interest prediction unit 13.

As explained above, in the image communication system according to this embodiment, the single or plural reference frames rf input and stored after the target frame are referred to in chronological order, and the region of interest in each reference frame rf is predicted. Based on the predicted region of interest par in the reference frame rf, the encoding parameter ep for the new input frame to be encoded is determined.

With this configuration, the image communication system according to this embodiment can more accurately predict the region of interest in the new input frame to be encoded by the encoder 11, and more appropriately determine the encoding parameter ep for that new input frame.

### Detailed Configuration of Image Communication System

Next, with reference to FIG. 2, the image communication system according to the first embodiment will be described in more detail. FIG. 2 is a detailed block diagram showing the configuration of the image communication system according to the first embodiment. As shown in FIG. 2, an image communication system according to this embodiment includes an image transmitting device 10, an image receiving device 20, and a communication channel 30. In FIG. 1, the image transmitting device 10 and the image receiving device 20 are not distinguished from each other, and the communication channel 30 is omitted.

For example, the image transmitting device 10 is mounted on a vehicle, and the image receiving device 20 is provided on a computer cloud. The input frame is, for example, an image signal that is input from an on-board camera or the like to the image transmitting device 10. The image transmitting device 10 and the image receiving device 20 are wirelessly connected to each other via the communication channel 30 such as a network.

As shown in FIG. 2, the image transmitting device 10 includes the encoder 11, the storage unit 12, the region-of-interest prediction unit 13, and the parameter determination unit 14 shown in FIG. 1. The image transmitting device 10 transmits the encoded frame ef generated by the encoder 11 to the image receiving device 20. The encoded frame ef is transmitted to the image receiving device 20 via the communication channel 30 such as a network.

As shown in FIG. 2, the image receiving device 20 includes the decoder 21, the image recognition unit 22, and the region-of-interest determination unit 23 shown in FIG. 1. The image receiving device 20 receives the encoded frame ef transmitted from the image transmitting device 10, and decodes it by using the decoder 21. The image receiving device 20 also transmits the region of interest ar of the target frame determined by the region-of-interest determination unit 23 to the image transmitting device 10. That is, the region of interest ar of the target frame is fed back to the image transmitting device 10.

First, the encoder 11 and storage unit 12 included in the image transmitting device 10 will be described. The encoder 11 encodes the input frame which is the image signal, based on the encoding parameter ep determined by the parameter determination unit 14. The encoded frame ef generated by the encoder 11 is input to the decoder 21. Meanwhile, the encoder 11 outputs, as a reference frame “rf”, the received input frame before being encoded to the storage unit 12.

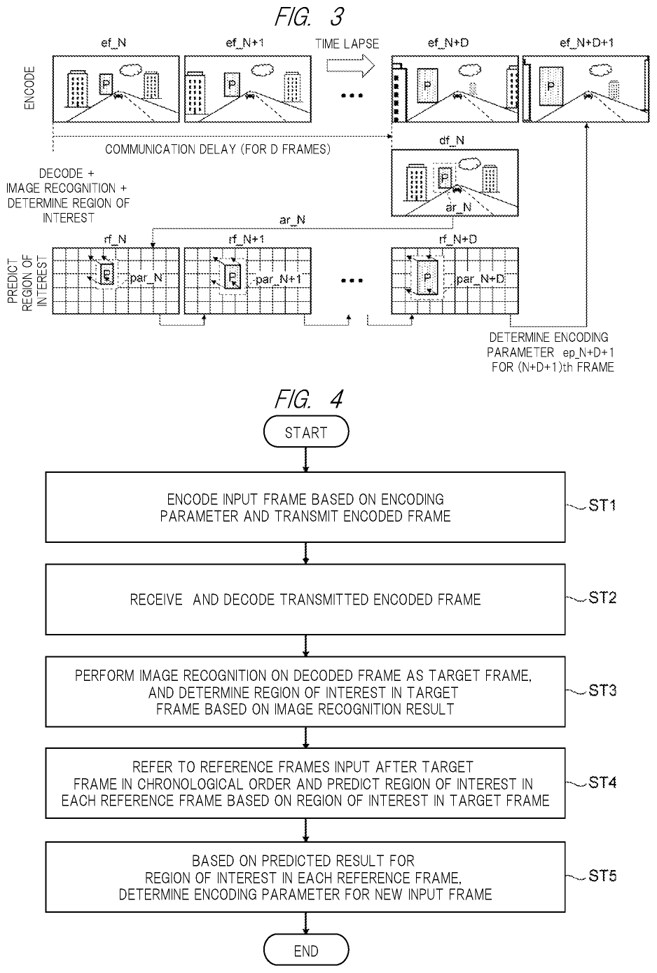

FIG. 3 is an image diagram showing a series of processes in the image communication system according to the first embodiment shown in FIG. 2. The upper side of FIG. 3 shows a plurality of encoded frames ef_N, ef_N+1, . . . , ef_N+D, ef_N+D+1 that are sequentially encoded by the encoder 11. Here, a term “N” indicates a frame input order, and is an optional natural number. A term “D” indicates a frame communication delay (number of frames), and is an optional natural number.

In the encoded frame such as ef_N shown in FIG. 3, as examples only, a road, a vehicle running ahead, a building, a parking lot “P”, and the sky (including clouds) and others are photographed. In the example of the encoded frame such as ef_N shown in FIG. 3, the parking lot P in the encoded frame such as ef_N is gradually made large. That is, the vehicle equipped with the on-board camera and the image transmitting device 10 is running to approach the parking lot P.

The storage unit 12 is made of, for example, a memory such as RAM, ROM, flash memory, and SSD described above. The storage unit 12 stores the reference frame rf received from the encoder 11. The storage 12 also stores the predicted region of interest par in the reference frame rf predicted by the region-of-interest prediction unit 13.

The lower side of FIG. 3 shows the reference frames rf_N, rf_N+1, . . . , rf_N+D stored in the storage unit 12. The reference frames rf_N, rf_N+1, . . . , rf_N+D are input frames before being encoded, and correspond to the encoded frames ef_N, ef_N+1, . . . , ef_N+D, respectively. As described in detail below, the storage unit 12 also stores a predicted region of interest par_N+D in the reference frame rf_N+D which is predicted by the region-of-interest prediction unit 13.

The storage unit 12 further stores motion vectors of the reference frames rf_N, rf_N+1, . . . , rf_N+D. In FIG. 3, the motion vectors are indicated schematically by arrows inside each reference frame such as rf_N. The motion vectors are calculated based on, for example, the sum of absolute difference (SAD).

Next, the decoder 21, the image recognition unit 22, and the region-of-interest determination unit 23 included in the image receiving device 20 will be described. The decoder 21 decodes the encoded frame ef generated by the encoder 11, and outputs the decoded frame df to the image recognition unit 22.

The middle of FIG. 3 shows the decoded frame df_N acquired by decoding the encoded frame ef_N of the target frame by the decoder 21. That is, the encoded frame ef_N corresponds to the decoded frame df_N in FIG. 3. In FIG. 3, the encoded frame ef_N and the decoded frame df_N are identically illustrated.

The image recognition unit 22 performs the image recognition on the decoded frame df generated by the decoder 21, and outputs the image recognition result rr to the region-of-interest determination unit 23. That is, in this embodiment, the target frame targeted for the image recognition performed by the image recognition unit 22 is the decoded frame df generated by the decoder 21.

The region-of-interest determination unit 23 determines the region of interest ar in the decoded frame df which is the target frame targeted for the image recognition, based on the image recognition result rr generated by the image recognition unit 22 and the surrounding information, and outputs the result to the region-of-interest prediction unit 13.

The surrounding information includes, for example, image information acquired from vehicles around the running position of the subject vehicle, traffic information around the running position of the subject vehicle, map information and the like. For example, when a user (for example, a driver) of the subject vehicle is looking for a parking lot, a parking lot where parking is available is determined as the region of interest ar based on the image recognition result rr and the surrounding information. Note that the surrounding information is not essential. Also, the number of the regions of interest ar may be plural.

In the decoded frame df_N shown in the middle of FIG. 3, the region of interest ar_N determined by the region-of-interest determination unit 23 is also included. In the example shown in FIG. 3, the attention is focused on the parking lot P where parking is available, and the parking lot P is included in the region of interest ar_N. Therefore, the user (for example, the driver) of the subject vehicle can pay attention to the parking lot P where parking is available.

Here, as shown in FIG. 3, a communication delay of D frames occurs in a period between the transmission of the encoded frame ef_N of the N-th input frame to the image receiving device 20 and the feeding back of the region of interest ar_N to the image transmitting device 10. That is, in the period of this communication delay, the N+1-th to N+D-th input frames are encoded, and the D encoded frames ef_N+1, . . . , ef_N+D shown in the upper side of FIG. 3 are generated. As shown in the lower side of FIG. 3, the N+1-th to N+D-th input frames are stored as reference frames rf_N+1, . . . , rf_N+D in the storage unit 12.

Next, the region-of-interest prediction unit 13 and the parameter determination unit 14 included in the image transmitting device 10 will be explained. The region-of-interest prediction unit 13 acquires the region of interest ar of the target frame determined by the region-of-interest determination unit 23, and refers to the reference frames rf having been input after the target frame and been stored in the storage unit 12, in chronological order. That is, the region-of-interest prediction unit 13 refers to the reference frames rf encoded during the communication delay of the target frame in chronological order, based on the region of interest ar of the target frame, and predicts the region of interest of each reference frame rf.

In detail, as shown in the lower side of FIG. 3, the predicted regions of interest par_N, . . . , par_N+D are sequentially predicted based on the region of interest ar of the decoded frame df_N which is the target frame, and the motion vectors in the reference frames rf_N, . . . , rf_N+D. The predicted regions of interest par_N, . . . , par_N+D include the parking lot P in the region of interest ar_N.

As a result, the region of interest in the new input frame to be encoded by the encoder 11 can be predicted more accurately. The encoded frame ef_N+D+1 shown in the upper side of FIG. 3 corresponds to the new input frame to be encoded by the encoder 11. Also, the predicted region of interest par_N+D in the reference frame rf_N+D shown in the lower side of FIG. 3 is stored in the storage unit 12.

From the storage unit 12, the parameter determination unit 14 acquires the predicted region of interest par in the reference frame rf predicted by the region-of-interest prediction unit 13. Based on the predicted region of interest par in the reference frame rf, the parameter determination unit 14 determines the encoding parameter ep for the new input frame to be encoded, and outputs it to the encoder 11. Note that the predicted region of interest par in the reference frame rf may be input from the region-of-interest prediction unit 13 to the parameter determination unit 14 not to be through the storage unit 12.

In the example shown in FIG. 3, the encoding parameter ep_N+D+1 for encoding the (N+D+1)-th input frame is determined based on the predicted region of interest par_N+D in the reference frame rf_N+D shown in the lower side of FIG. 3. Then, a new encoded frame ef_N+D+1 shown in the upper side of FIG. 3 is generated based on the encoding parameter ep_N+D+1.

The encoding parameter ep is determined so that, for example, the region of interest in the new input frame has higher image quality than those of other regions. For example, the encoding parameter ep includes a quantization parameter, and the parameter determination unit 14 makes the quantization parameter smaller in the region of interest than in other regions.

Note that the input frame may be input to the encoder 11 through a deblocking filter (not illustrated). In this case, the encoding parameter ep may include a parameter related to the deblocking filter.

As explained above, the image communication system according to this embodiment refers to the single or plural reference frames rf input and stored after the target frame, in chronological order, and predicts the region of interest in each reference frame rf. The encoding parameter ep for the new input frame to be encoded is determined based on the predicted region of interest par in each reference frame rf.

With this configuration, the image communication system according to this embodiment can more accurately predict the region of interest in the new input frame to be encoded by the encoder 11, and more appropriately determine the encoding parameter ep for this new input frame.

### Image Communication Method

Next, with reference to FIG. 4, an image communication method according to the first embodiment will be described. FIG. 4 is a flowchart showing the image communication method according to the first embodiment. FIG. 4 will be explained with reference to FIG. 2 and FIG. 3 as appropriate.

First, as shown in FIG. 2 and FIG. 4, the encoder 11 encodes and transmits the input frame which is the image signal, based on the encoding parameter ep determined by the parameter determination unit 14 (step ST1). At this time, the N-th encoded frame ef_N is generated as shown in the upper side of FIG. 3. Also, the N-th input frame is stored as the reference frame rf_N in the storage unit 12 as shown in the lower side of FIG. 3.

Next, as shown in FIG. 2 and FIG. 4, the decoder 21 decodes the encoded frame ef generated by the encoder 11, and outputs the decoded frame df to the image recognition unit 22 (step ST2). At this time, the N-th decoded frame df_N is generated as shown in the middle of FIG. 3.

Next, as shown in FIG. 2 and FIG. 4, the image recognition unit 22 performs the image recognition on the decoded frame df generated by the decoder 21, and outputs the image recognition result rr to the region-of-interest determination unit 23. Subsequently, the region-of-interest determination unit 23 determines the region of interest ar in the decoded frame df which is the target frame targeted for the image recognition, based on the image recognition result rr made by the image recognition unit 22 and the surrounding information, and outputs it to the region-of-interest prediction unit 13 (step ST3). At this time, the region of interest ar_N is determined in the decoded frame df_N as shown in the middle of FIG. 3.

Here, as shown in FIG. 3, the communication delay of D frames occurs in the period between the transmission of the encoded frame ef_N of the N-th input frame to the image receiving device 20 and the feeding back of the region of interest ar_N to the image transmitting device 10. That is, during the communication delay, the N+1-th to N+D-th input frames are encoded, and the D encoded frames ef_N+1, . . . , ef_N+D shown in the upper side of FIG. 3 are generated. Also, the N+1-th to N+D-th input frames are stored as reference frames rf_N+1, . . . , rf_N+D in the storage unit 12 as shown in the lower side of FIG. 3.

Next, as shown in FIG. 2 and FIG. 4, the region-of-interest prediction unit 13 refers to the reference frames rf input by the encoder 11 after the target frame and stored in the storage unit 12, in chronological order. Then, the region-of-interest prediction unit 13 predicts the region of interest of each reference frame rf, based on the region of interest ar of the target frame (step ST4).

At this time, in detail, as shown in the lower side of FIG. 3, the predicted regions of interest par_N, . . . , par_N+D are sequentially predicted based on the region of interest ar of the decoded frame df_N which is the target frame and the motion vectors in the reference frames rf_N, . . . , rf_N+D.

Finally, as shown in FIG. 2 and FIG. 4, based on the predicted region of interest par in the reference frame rf, the parameter determination unit 14 determines the encoding parameter ep for the new input frame to be encoded (step ST5). Then, the encoder 11 encodes the new input frame based on this encoding parameter ep.

In this case, in the example shown in FIG. 3, the encoding parameter ep_N+D+1 for encoding the (N+D+1)-th input frame is determined based on the predicted region of interest par_N+D in the reference frame rf_N+D shown in the lower side of FIG. 3. Then, based on the encoding parameter ep_N+D+1, the new encoded frame ef_N+D+1 shown in the upper side of FIG. 3 is generated by the encoder 11.

As explained above, in the image communication method according to this embodiment, single or plural reference frames rf input and stored after the target frame are referred to in chronological order to predict the region of interest in each reference frame rf. Based on the predicted region of interest par in the reference frame rf, the encoding parameter ep for the new input frame to be encoded is determined.

With this configuration, the image communication system according to this embodiment can more accurately predict the region of interest in the new input frame to be encoded by the encoder 11, and more appropriately determine the encoding parameter ep for the new input frame.

### Second Embodiment

### Detailed Configuration of Image Communication System

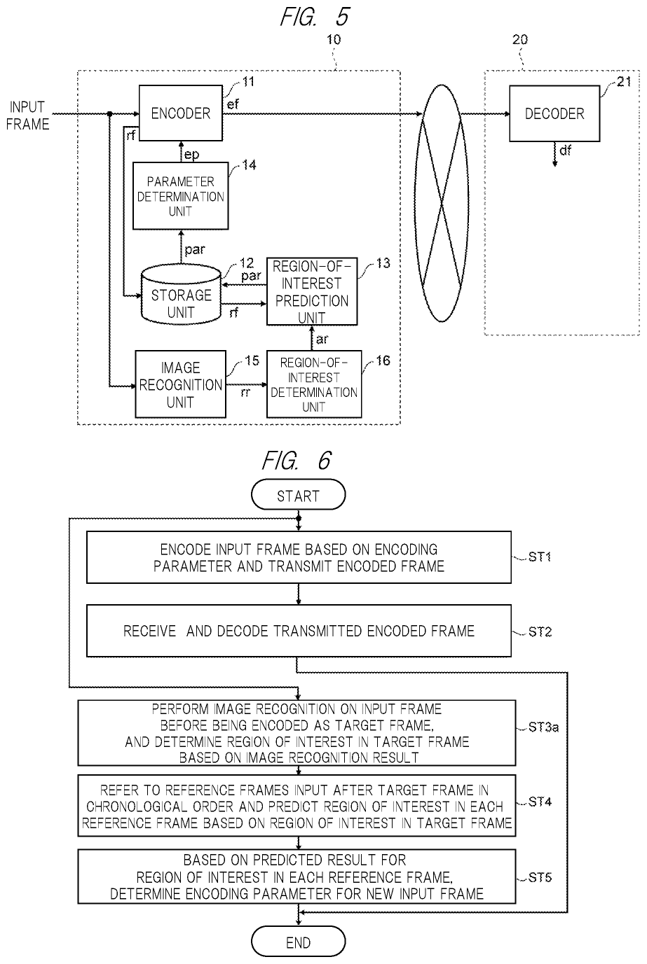

Next, with reference to FIG. 5, an image communication system according to a second embodiment will be described. FIG. 5 is a detailed block diagram showing a configuration of the image communication system according to the second embodiment.

As shown in FIG. 5, the image communication system according to this embodiment also includes the image transmitting device 10, the image receiving device 20, and the communication channel 30 as similar to the first embodiment shown in FIG. 2.

As shown in FIG. 5, in the image communication system according to this embodiment, the image transmitting device 10 includes an image recognition unit 15 and a region-of-interest determination unit 16 in addition to the encoder 11, the storage unit 12, the region-of-interest prediction unit 13, and the parameter determination unit 14 shown in FIG. 2. Meanwhile, the image receiving device 20 includes the decoder 21 shown in FIG. 2, but does not include the image recognition unit 22 and the region-of-interest determination unit 23.

As shown in FIG. 5, the image recognition unit 15 performs the image recognition on the input frame before being encoded by the encoder 11, and outputs the image recognition result rr to the region-of-interest determination unit 16. That is, in this embodiment, the target frame targeted for the image recognition by the image recognition unit 15 is the input frame before being encoded by the encoder 11.

The region-of-interest determination unit 16 determines the region of interest ar in the decoded frame df which is the target frame targeted for the image recognition, based on the image recognition result rr made by the image recognition unit 15, and outputs it to the region-of-interest prediction unit 13. Note that the region-of-interest determination unit 16 may determine the region of interest ar based on the surrounding information in addition to the image recognition result rr, as similar to the region-of-interest determination unit 23 shown in FIG. 2.

The region-of-interest prediction unit 13 acquires the region of interest ar of the target frame determined by the region-of-interest determination unit 16, and refers to the reference frames rf input after the target frame and stored in the storage unit 12, in chronological order. That is, the region-of-interest prediction unit 13 refers to the reference frames rf input during the communication delay of the target frame in chronological order, based on the region of interest ar of the target frame, and predicts the region of interest of each reference frame rf.

From the storage unit 12, the parameter determination unit 14 acquires the predicted region of interest par in the reference frame rf predicted by the region-of-interest prediction unit 13. Based on the predicted region of interest par in the reference frame rf, the parameter determination unit 14 determines the encoding parameter ep for the new input frame to be encoded, and outputs it to the encoder 11.

As explained above, the image communication system according to this embodiment also refers to single or plural reference frames rf input and stored after the target frame, in chronological order, and predicts the region of interest in each reference frame rf. Based on the predicted region of interest par in the reference frame rf, the encoding parameter ep for the new input frame to be encoded is determined.

With this configuration, the image communication system according to this embodiment can also more accurately predict the region of interest in the new input frame to be encoded by the encoder 11, and more appropriately determine the encoding parameter ep for this new input frame.

Furthermore, in the image communication system according to the first embodiment, the region of interest ar determined by the region-of-interest determination unit 23 of the image receiving device 20 is fed back to the region-of-interest prediction unit 13 of the image transmitting device 10. On the other hand, in the image communication system according to this embodiment, the region-of-interest prediction unit 13 predicts the region of interest of each reference frame rf, based on the region of interest ar determined by the region-of-interest determination unit 16 in the image transmitting device 10. Therefore, the frame delay is small, and the number of reference frames rf referenced by the region-of-interest prediction unit 13 can be reduced. Other configurations are the same as in the first embodiment, and therefore, are omitted.

### Image Communication Method

Next, with reference to FIG. 6, an image communication method according to the second embodiment will be described. FIG. 6 is a flowchart showing the image communication method according to the second embodiment. FIG. 6 will be explained with reference to FIG. 5 as appropriate. Steps ST1 and ST2 shown in FIG. 6 are the same as the steps ST1 and ST2 shown in FIG. 4, and therefore, the explanation thereof is omitted.

As shown in FIG. 5 and FIG. 6, in parallel with steps ST1 and ST2, the image recognition unit 15 performs the image recognition on the input frame before being encoded, and outputs the image recognition result rr to the region-of-interest determination unit 16. Then, based on the image recognition result rr made by the image recognition unit 15, the region-of-interest determination unit 16 determines the region of interest ar in the input frame before being encoded, which is the target frame targeted for the image recognition, and outputs it to the region-of-interest prediction unit 13 (step ST3a).

Next, as shown in FIG. 5 and FIG. 6, the region-of-interest prediction unit 13 refers to the reference frames rf input after the target frame and stored in the storage unit 12, in chronological order. Then, the region-of-interest prediction unit 13 predicts the region of interest of each reference frame rf, based on the region of interest ar of the target frame (step ST4).

Finally, as shown in FIG. 5 and FIG. 6, based on the predicted region of interest par in each reference frame rf, the parameter determination unit 14 determines the encoding parameter ep for the new input frame to be encoded (step ST5). Then, the encoder 11 encodes the new input frame, based on this encoding parameter ep.

As explained above, the image communication method according to this embodiment also refers to single or plural reference frames rf input and stored after the target frame, in chronological order, and predicts the region of interest in each reference frame rf. Based on the predicted region of interest par in the reference frame rf, the encoding parameter ep for the new input frame to be encoded is determined.

With this configuration, the image communication method according to this embodiment can more accurately predict the region of interest in the new input frame to be encoded by the encoder 11, and more appropriately determine the encoding parameter ep for the new input frame.

In the foregoing, the invention made by the inventors of the present application has been concretely described on the basis of the embodiments. However, it is needless to say that the present invention is not limited to the foregoing embodiments, and various modifications can be made within the scope of the present invention.

What is claimed is:

1. An image communication system comprising:
an encoder configured to encode an input frame, based on an encoding parameter;
a storage unit configured to store the input frame;
a decoder configured to decode an encoded frame generated by the encoder;
an image recognition unit configured to perform image recognition on a target frame;
a region-of-interest determination unit configured to determine a region of interest in the target frame, based on a result of the image recognition performed by the image recognition unit;
a region-of-interest prediction unit configured to refer to single or plural reference frames input after the target frame and stored in the storage unit, in chronological order, and configured to predict a region of interest in the reference frame(s), based on the region of interest in the target frame; and
a parameter determination unit configured to determine the encoding parameter for a new input frame to be encoded, based on a predicted region of interest predicted in the reference frame(s) by the region-of-interest prediction unit.

2. The image communication system according to claim 1,
wherein the encoding parameter includes a quantization parameter, and
wherein the parameter determination unit makes the quantization parameter smaller in a region of interest in the new input frame than in other regions.

3. The image communication system according to claim 1,
wherein the image communication system includes an image transmitting device and an image receiving device,
wherein the image transmitting device includes the encoder, the storage unit, the region-of-interest prediction unit, and the parameter determination unit, and transmits the encoded frame to the image receiving device,
wherein the image receiving device includes the decoder, the image recognition unit, and the region-of-interest determination unit, and receives and decodes the encoded frame transmitted from the image transmitting device, and transmits the region of interest determined by the region-of-interest determination unit to the image transmitting device, and
wherein the target frame targeted for the image recognition by the image recognition unit is a decoded frame generated by the decoder.

4. The image communication system according to claim 3,
wherein the image transmitting device is mounted on a vehicle, and
wherein the image receiving device is provided on a computer cloud and is wirelessly connected to the image transmitting device.

5. The image communication system according to claim 1,
wherein the image communication system includes an image transmitting device and an image receiving device,
wherein the image transmitting device includes the encoder, the image recognition unit, the region-of-interest determination unit, the region-of-interest prediction unit, and the parameter determination unit, and transmits the encoded frame to the image receiving device,
wherein the target frame targeted for the image recognition by the image recognition unit is the input frame before being encoded by the encoder, and
wherein the image receiving device includes the decoder, and receives and decodes the encoded frame transmitted from the image transmitting device.

6. The image communication system according to claim 5,
wherein the image transmitting device is mounted on a vehicle, and
wherein the image receiving device is provided on a computer cloud and is wirelessly connected to the image transmitting device.

7. An image communication method comprising steps of:
transmitting an encoded frame generated from an input frame, based on an encoding parameter,
receiving and decoding the encoded frame;
performing image recognition on a target frame, and determining a region of interest in the target frame, based on a result of the image recognition;
referring to single or plural reference frames input and stored after the target frame, in chronological order, and predicting a region of interest in the reference frame(s), based on the region of interest in the target frame; and
determining the encoding parameter for a new input frame to be encoded, based on a predicted region of interest predicted in the reference frame(s).

8. The image communication method according to claim 7,
wherein the encoding parameter includes a quantization parameter, and
wherein the image communication method further comprises making the quantization parameter smaller in a region of interest in the new input frame than in other regions.

9. The image communication method according to claim 7,
wherein the target frame targeted for the image recognition is a decoded frame generated from the encoded frame.

10. The image communication method according to claim 7,
wherein the target frame targeted for the image recognition is the input frame before being encoded.

11. An image transmitting device comprising:
an encoder configured to encode an input frame, based on an encoding parameter;
a storage unit configured to store the input frame;
an image recognition unit configured to perform image recognition on the input frame before being encoded as a target frame;
a region-of-interest determination unit configured to determine a region of interest in the target frame, based on a result of the image recognition performed by the image recognition unit;
a region-of-interest prediction unit configured to refer to single or plural reference frames input after the target frame and stored in the storage unit, in chronological order, and configured to predict a region of interest in the reference frame(s), based on the region of interest in the target frame; and
a parameter determination unit configured to determine the encoding parameter for a new input frame to be encoded, based on a predicted region of interest predicted in the reference frame(s) by the region-of-interest prediction unit.

12. The image transmitting device according to claim 11,
wherein the encoding parameter includes a quantization parameter, and
wherein the parameter determination unit makes the quantization parameter smaller in a region of interest in the new input frame than in other regions.

13. The image transmitting device according to claim 11,
wherein the image transmitting device is mounted on a vehicle.
